(19) United States
(12) Patent Application Publication
(10) Pub. No.: US 2003/0052810 A1
(43) Pub. Date: Mar. 20, 2003

(54) Device to conceal a radar representing a pattern in relief, equipping especially a vehicle, and detection system comprising such a device

(75) Inventors: Jean-Paul Artis, Plouzane (FR); Thierry Dousset, Saint-Gratien (FR); Patrick Le Sayec, Montfort L'Amaury (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: THALES, PARIS (FR)

(21) Appl. No.: 10/188,827

(22) Filed: Jul. 5, 2002

(30) Foreign Application Priority Data
Jul. 6, 2001 (FR) 01 09028

(51) Int. Cl. H01Q 17/00; H01Q 1/42

(52) U.S. Cl. 342/1; 342/3; 342/4; 343/872

(57) ABSTRACT

A device to conceal a radar or any other system for the transmission and reception of electromagnetic waves represents, for example, a pattern in relief. The device comprises at least one front part transparent to electromagnetic and optical waves, one rear part transparent to electromagnetic waves facing transmission and/or reception means and a form representing the manufacturer's logo placed between the parts. This form has an cellular structure with RF characteristics close to those of air. That device can be applied especially in radars equipping vehicles.

### BACKGROUND OF THE INVENTION

1. Field of the Invention

The present invention relates to a device to conceal a radar or any other system for the transmission and reception of electromagnetic waves. This device represents, for example, a pattern in relief. The invention also relates to a radar whose radome is formed by a device of this kind. The invention can be applied especially to radars fitted into vehicles.

2. Description of the Prior Art

For safety reasons in particular, it is planned to equip automobiles with radars. An exemplary known radar is the ACC (Automotive Cruise Control) radar. A radar of this kind is used especially to regulate the speed of vehicles according to traffic. In other words, the radar detects the speed and distance of vehicles that precede the radar-bearing vehicle so as to maintain, especially, a minimum inter-vehicle safety distance. The radar can also be used to determine obstacles in the path of the vehicle.

This radar must therefore be integrated into the front of the automobile, at a preferred position which, for example, could be located behind the radiator grille, on the traditional position of the manufacturer's logo or emblem. In this case, the means used to conceal the radar must fulfill the following functions at the same time:

letting through microwaves with the lowest possible attenuation;

bearing a pattern representing the manufacturer's logo.

In particular, this pattern may have an aspect of depth or volume, as well as a shiny or glossy metallic appearance, for example of the chromium-plated or gold-plated type.

To present an aspect of volume, there are known ways of stacking layers, generally made of plastic, whose thickness is complementary in such a way that the electrical wave emitted by the radar encounters a constant thickness of material throughout the surface of the pattern. In other words, the variations of the wave due to the attenuation or phase-shift introduced by the stacking of layers are constant throughout the surface. Apart from total attenuation, the radiation patterns of the radar antenna are unaffected or little affected.

The effects of volume related to this method have an amplitude linked to the total thickness of the pattern and therefore soon prove to be limited. Indeed, in the millimeter band corresponding to the frequencies used, especially for ACC radars, the microwave losses corresponding to plastic materials increase rapidly with the thickness of the material crossed.

Finally, for obvious economic reasons, the logo or any other part connected to a vehicle must have the lowest possible cost.

### SUMMARY OF THE INVENTION

It is an aim of the invention to overcome the above-mentioned drawbacks, especially to enable the making of a device to conceal a radar having an aspect of volume or depth with low microwave losses.

To this end, an object of the invention is a device for the concealment of means for the transmission and/or reception of an electromagnetic wave, the device comprising at least one front part transparent to electromagnetic and optical waves, one rear part transparent to electromagnetic waves facing the transmission and/or reception means and a form representing a pattern placed between the front and rear parts, this form having a cellular structure.

The cellular structure is, for example, a foam with RF characteristics close to those of air. The form may be covered with a coating that has a shiny appearance.

Advantageously, the distance between the rear and front parts is such that the waves reflected by each of them are close to phase opposition.

The phase relationship may advantageously be optimized by compensation for the phase-shift created by the pattern, by a variation in the thickness, with respect to the form, of one of the parts, namely the front and rear parts, or of both together.

Advantageously, the device comprises a hole to equalize the pressure between the interior and the exterior so as to prevent the entry of moisture and the formation of condensation.

The pattern may of course represent an automobile manufacturer's logo.

An object of the invention is also a radar fitted into a vehicle whose radome is constituted by the above device.

### BRIEF DESCRIPTION OF THE DRAWINGS

Other features and advantages of the invention shall appear from the following description, made with reference to the appended drawings, of which:

FIG. 1 shows a possible embodiment of a device according to the invention, the device facing a system of electromagnetic transmission and/or reception that it protects;

FIGS. 2 and 3 show two exemplary embodiments of the coating that covers the surface of a form used in a device according to the invention, especially to give this form a shiny appearance;

FIG. 4 shows another possible embodiment of a device according to the invention.

### MORE DETAILED DESCRIPTION

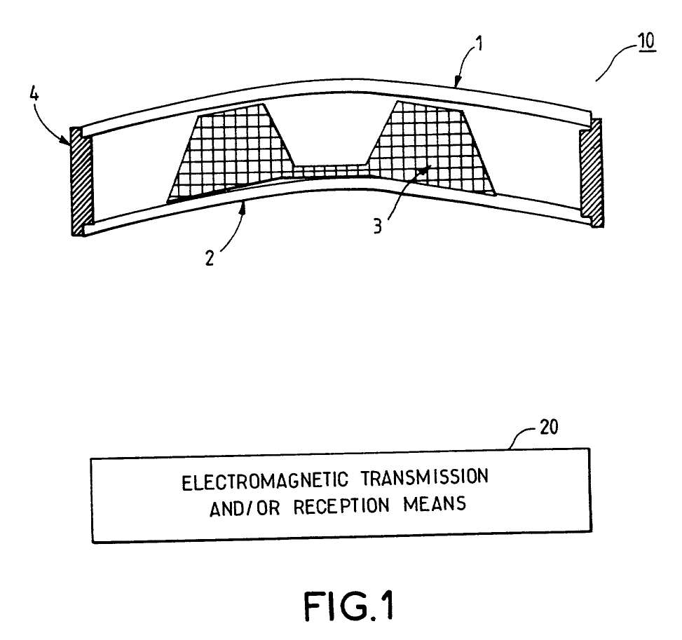

FIG. 1 illustrates a possible embodiment of the device 10 according to the invention to conceal a radar. By way of an example, the description takes the case where this device has a pattern representing the logo of an automobile manufacturer. Besides, the radar forms the equipment of an automobile. Naturally, the device according to the invention may comprise any other pattern and conceal other types of radar or electromagnetic wave transmission and/or reception means 20. A device 10 according to the invention uses, in particular, two plates 1, 2 between which a form 3 may be inserted. This form essentially has a thickness that is not negligible. The thickness for example is not uniform so as to represent especially a given form such as a logo.

The device 10 therefore comprises a front plate 1 transparent to microwaves and to optical waves. With respect to the optical waves, it is at least made of translucent material. This front plate 1 is for example made of transparent plastic, such as polycarbonate for example. The device 10 furthermore comprises a rear plate 2, facing electromagnetic transmission and/or reception means 20, transparent to microwaves. This plate may be tinted, depending on the effect sought which may be, for example, to represent a background on which the pattern is located. This background may equally well be dark or shiny or both together, or again it may represent any other plane pattern. Preferably, the plates 1, 2 are parallel to each other. They are for example curved so as to match the front profile of a vehicle. They thus represent, for example, a spherical or cylindrical portion.

The front and rear faces 1, 2 are preferably as identical as possible in their RF properties. Their thickness is, for example, close to or substantially equal to the matching thickness defined by a multiple of the half wavelength in the material considered at normal incidence. This matching thickness eo is given by the following relationship:

$${e}_{0} = \frac{k {λ}_{0}}{2 \sqrt{( {ϵ}_{r} - {sin}^{2} θ )}} \qquad ( 1 )$$

where λ₀ represents the length of the microwave in air, εᵣ the dielectric constant of the material of the form 3 and θ the mean angle of incidence of the wave with respect to the surface crossed.

The form 3 placed in the free space between the front and rear plates 1, 2 represents or comprises the pattern. This pattern is for example an automobile manufacturer's logo. This form 3 is constituted by a material with low losses and a low dielectric constant. Advantageously, this material has a cellular structure, for example of the foam type. Thus, this material is for example a polystyrene, acrylic or polyurethane type of closed-cell foam. In particular, polymethacrylimide foam may be very appropriate. More generally, the structures or the foams chosen have RF characteristics close to that of air especially with a relative dielectric constant εᵣ very close to 1 and preferably a very low loss tangent δ, for example lower than 0.001. Consequently, the waves are little affected when crossing this type of material.

The form 3 is for example bonded to one of the plates 1, 2, preferably to the rear plate 2. Any other mode of joining is of course possible.

The pattern does not necessarily cover the entire surface illuminated by the radar 20, or any other means of transmission/reception. The protection is provided especially by the plates 1, 2.

Advantageously, the form 3 may be covered on all or part of its surface with paint or with a coating with low dielectric losses. In particular, in order to present a shiny appearance, it may be coated with a shiny film such as, for example, film used for the opaque treatment of windows in buildings or for making electrical lighting reflectors.

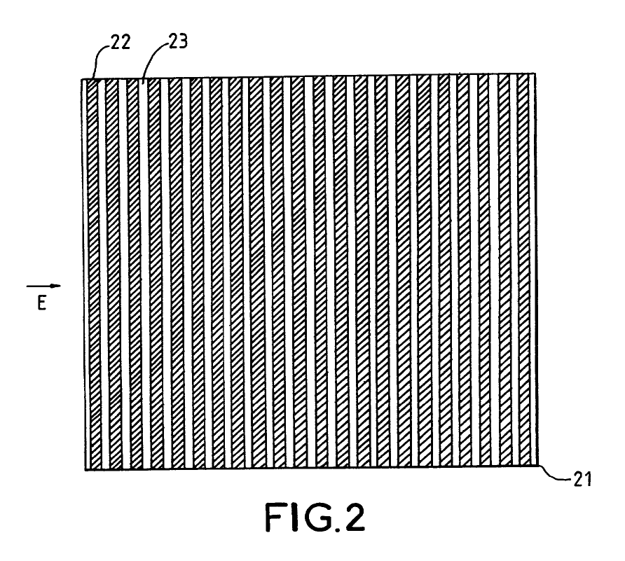

FIG. 2 illustrates another exemplary coating 21 applied to the form 3. This coating 21 has a shiny appearance. This coating has a network of conductive zones 22 having a direction substantially perpendicular to the polarization of the wave sent out by the radar 20, namely a direction perpendicular to the electrical field E of the wave. Owing to the smaller wavelength of the band allocated to an automobile radar for example, the network of wires may be extremely fine and closely packed, and thus faithfully reproduce shiny appearance of the kind obtained in an uninterrupted structure. In particular, the network of wires may then give a shiny appearance similar to that of solid or uninterrupted chromium, of the kind used commonly. Preferably, especially for simplification of manufacture, the network of wires is constituted throughout the surface by the coating 21. This network is fixed to a support transparent to microwaves. This support is furthermore flexible so as to match the form 3. For example, the width of the conductive regions 22, or wires, may be in the range of 0.15 mm, as also the spacing 23 between the two edges of zones or between consecutive wires. Such an arrangement of the wires of the network introduces negligible microwave losses and also a negligible phase rotation. This means that the radiation characteristics of the radar antenna are not particularly modified.

This wire network 22 may be deposited on the support by any moralization or etching technique. The etching precision required is compatible with techniques that can be used for large-scale production. Given especially the low influence of the resistivity of a conductive wire 22 in the process of the wave, the wire network may incorporate a wide variety of metals, especially chromium, copper, silver or gold. The conductive wires may thus be constituted by these metals or coated with these metals. This makes it possible especially to provide a variety of effects and reproduce especially a large number of logos. Advantageously, the front plate 1 protects the wire network against external aggression, especially climatic or mechanical aggression.

FIG. 3 illustrates another possible embodiment of a coating based on a network of wires. The wire network, as described with reference to FIG. 2, may give an appearance that may be deemed to be insufficiently shiny owing to the presence of non-metallised regions 23. It is possible to make a coating 21 having an uninterrupted shiny appearance or one that is close to it by superimposing at least two networks of wires 31, 32, for example in a staggered position, with the wires being parallel. The two networks are thus for example staggered by a ½ pitch. Thus, if the width of a wire is for example 0.15 mm and the width of the spacing between wires is equal to 0.30 mm, then the pitch is equal to 0.30 mm. More generally, a pitch of the network corresponds to the width of a wire plus the width of a spacing 23. The first network of wires 31 is therefore separated from the second network of wires 32 by a flexible median support 35 that is transparent to optical waves and microwaves. The first network of wires 31 is for example fixed to the median substrate 35, for example by metallization. The second network of wires 32 is for example fixed to a bottom substrate 37, for example by metallization. Advantageously, an electrical current may cross all or part of the wires 42 of the network. The heating of the wires thus produced may, for example, enable the de-icing of the logo, especially the shiny part, and thus make it clearly visible, especially in wintry conditions. The heating of the wires may also prevent condensation. Should several networks be superimposed, all the networks or only the outwardly-oriented network 31 may be crossed by a current.

A part 4, for example a frame or a strap, provides for the mechanical holding of the front and rear plates as well as for fixing the assembly to the vehicle. The plates 1, 2 and the frame 4 are preferably assembled in a tightly sealed way, for example by bonding. In one of the parts, for example in the frame 4 an open-air passage may be made, and possibly complemented by a water-vapor-tight membrane enabling the balancing of the internal and external pressures so as to prevent any collection of moisture that could give rise to condensation.

The part 4 therefore enables the plates 1, 2 to be kept at a given distance. This distance is preferably chosen so that the return wave from the front plate 1 is in phase opposition with that of the rear plate 2. The plates 1, 2 are designed to be identical in RF terms. This results in a cancellation or at least a minimizing of the return wave and consequently a minimizing of the mis-matching losses of the assembly. The spacing d between the two plates is thus for example substantially identical to the distance do given by the following relationship:

$${d}_{0}^{*} = \frac{( 2 k + 1 ) {λ}_{0}}{4 - e {λ}_{0} / {λ}_{m}} \qquad ( 2 )$$

where, as further above, λ₀ represents the length of the microwave in air and λₘ represents the wavelength in the material constituting the plates 1, 2 and e the thickness between these plates.

The way in which the parts 1, 2, 4 are mounted is given by a way of an indication. Other modes of joining are, of course, possible, especially depending on mounting or manufacturing constraints. In particular, the rear plate 2 and the frame 4 may form one and the same part.

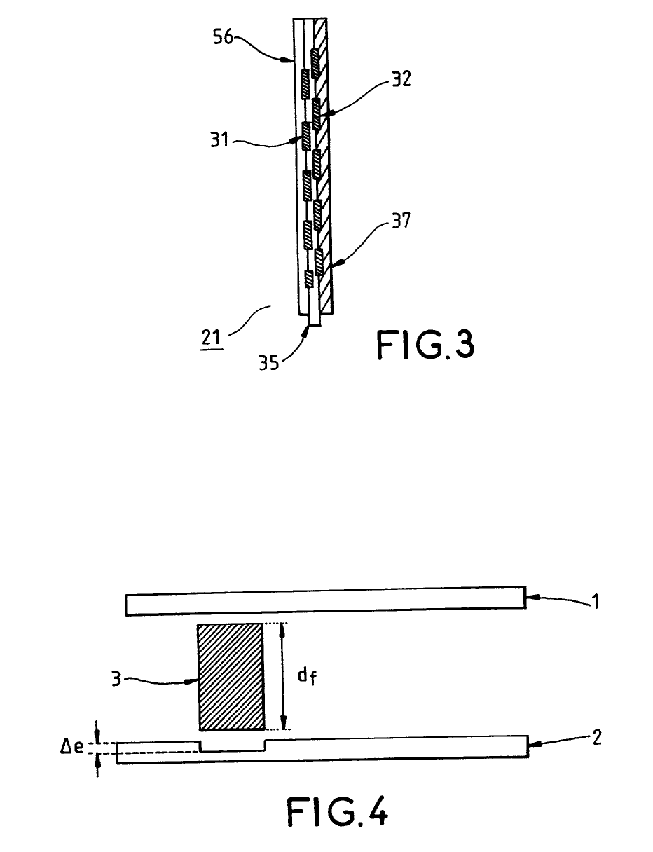

FIG. 4 illustrates another embodiment of a device according to the invention that takes account of the differences in the path of an electromagnetic wave between the two plates 1, 2. In particular, it may happen that the radio characteristics or the configuration of the form 3 are such that a wave crossing this form undergoes a phase shift with respect to a path in air. In this case, it is possible to play on the thickness of one of the plates at least, preferably the rear plate 2, to compensate for this phase shift. Thus, depending on the form 3, the thickness of the back plate may, for example, be reduced by a thickness Δe to compensate for the phase shift prompted by the form. This variation in thickness Δe to be applied is, for example, close or substantially equal to the variation Δe₀ given by the following relationship:

$$Δ {e}_{0} = \frac{ΔΦ \cdot {λ}_{0}}{2 π \sqrt{{ϵ}_{m}}} \qquad ( 3 )$$

where λ₀ again represents the length of the microwave in air, and εₘ represents the dielectric constant of the material constituting the plate and ΔΦ s represents the phase difference to be compensated for.

This phase difference is given approximately by the following relationship:

$$ΔΦ = \frac{2 π \cdot {d}_{f} \cdot \sqrt{{ϵ}_{v} - 1}}{{λ}_{0}} \qquad ( 4 )$$

where d_{f} represents the thickness of the form 3 and εᵥ the dielectric constant of the material constituting this form 3.

Advantageously, the variation in thickness Ae facilitates the mounting and the positioning of the form 3 on the rear plate 2.

The recessed variation in thickness may be obtained on the rear plate 2 as well as on the front plate 1, or on both together.

A device as described here above may, for example, protect an ACC radar. It may also constitute the radome of any other type of radar with which an automobile is equipped and may be located, for example, on the front of this automobile.

What is claimed is:

1. A device for the concealment of means for the transmission and/or reception of an electromagnetic wave, the device comprising at least one front part transparent to electromagnetic and optical waves, one rear part transparent to electromagnetic waves facing the transmission and/or reception means and a form representing a pattern placed between the front and rear parts, this form having a cellular structure.

2. A device according to claim 1, wherein the cellular structure has radio characteristics close to those of air.

3. A device according to any of the above claims, wherein the cellular structure is a foam.

4. A device according to any of the above claims, wherein the surface of the form is covered with a coating.

5. A device according to claim 4, wherein the coating has a shiny appearance.

6. A device according to claim 5, wherein the coating has at least one network of conductive wires substantially perpendicular to the polarization of the electromagnetic wave.

7. A device according to claim 6, wherein the coating comprises at least two parallel, superimposed networks of wires.

8. A device according to claim 7, wherein the two networks are offset by a half-pitch.

9. A device according to any of the claims 6 to 7, wherein at least one part of the wires is crossed by an electric current to obtain a heating.

10. A device according to claim 5, wherein the coating is a shiny film.

11. A device according to any of the above claims, comprising an air passage to equalize the pressures between the exterior and the interior.

12. A device according to claim 11, wherein the passage is supplemented by a water-vapor-tight membrane.

13. A device according to any of the above claims, wherein the front and rear parts are substantially parallel to each other.

14. A device according to any of the above claims, wherein the front and rear parts are curved to match the front profile of a vehicle.

15. A device according to any of the above claims, wherein the front and rear parts are separated by a distance such that the waves reflected by each of them are substantially equal in amplitude and are in phase opposition.

16. A device according to any of the above claims, wherein a variation in thickness (Δe) is created, facing the form on at least one of the parts, namely the front or rear parts, to compensate for the phase shift created by the form.

17. A device according to claim 16, wherein the variation is a recessed variation.

18. A device according to any of the above claims, wherein the form is made of polymethacrylimide foam.

19. A device according to any of the claims 1 to 18, wherein the form is made of a polystyrene, acrylic or polyurethane type of foam.

20. A device according to any of the above claims, wherein the pattern represents the logo of an automobile manufacturer.

21. A radar equipping a vehicle, wherein its radome is constituted by a device according to any of the above claims.

22. A radar according to claim 21, placed in the front of the vehicle.
